(19) United States
(12) Patent Application Publication
(10) Pub. No.: US 2007/0040543 A1
(43) Pub. Date: Feb. 22, 2007

(54) Bandgap reference circuit

(76) Inventors: Kok-Soon Yeo, Singapore (SG); Lian-Chun Xu, Singapore (SG); Wai Keat Tai, Singapore (SG); Chee-Keong Teo, Singapore (SG); John J.De Leon Asuncion, Singapore (SG)

Correspondence Address: AVAGO TECHNOLOGIES, LTD., P.O. BOX 1920, DENVER, CO, 80201-1920, US

(21) Appl. No.: 11/204,352

(22) Filed: Aug. 16, 2005

(51) Int. Cl. G05F 3/16; G05F 3/20

(52) U.S. Cl. 323/313

(57) ABSTRACT

A bandgap circuit includes a current mirror that generates a proportional to absolute temperature current at an output node that outputs the bandgap reference voltage. A first current path including a first resistor is coupled between the output node and a first bipolar transistor. The second current path including a second resistor is coupled between the output node and a second bipolar transistor. The first current path is parallel to the second current path. The circuit outputs a bandgap reference voltage.

### TECHNICAL FIELD

The invention relates to voltage reference circuits, specifically to first order temperature compensated bandgap reference circuits.

### BACKGROUND

Many analog and digital circuits rely on an internal reference voltage to produce and reproduce accurate signals. For example, the conversion accuracy of signals from analog to digital and digital to analog, in precision analog to digital converters (ADCs) and digital to analog converters (DACs), directly depends on the accuracy of the internal reference voltage. To be effective, the internal reference voltage must remain unchanged even with variations in temperature, supply voltage, or other conditions or variations associated with the circuit.

One way to obtain a reference voltage is to use the bandgap energy characteristics of a semiconductor. Bandgap energy is the energy difference between the bottom of the conduction band and the top of the valance band of a semiconductor. Though varying with temperature, the bandgap energy is a physical constant when extrapolated to a temperature of zero Kelvin (absolute zero). Consequently, basing a reference voltage on the bandgap energy can provide a consistent reference voltage (Vbandgap) with low sensitivity to temperature and supply voltage. One way to obtain the bandgap voltage is to measure the voltage across a forward biased semiconductor p-n junction device such as a transistor. Measuring the forward biased semiconductor p-n voltage measures the bandgap energy of the semiconductor and provides a stable reference voltage. In conventional bandgap circuits, components such as transistors and resistors must be matched to very close tolerances to achieve a stable reference voltage. If these components are not matched to the required tolerances, the reference voltage may vary considerably with changing conditions such as temperature.

### SUMMARY

A bandgap circuit includes a current mirror that generates a proportional to absolute temperature current at an output node that outputs the bandgap reference voltage. A first current path including a first resistor is coupled between the output node and a first bipolar transistor. The second current path including a second resistor is coupled between the output node and a second bipolar transistor. The first current path is parallel to the second current path. The circuit outputs a bandgap reference voltage.

### BRIEF DESCRIPTION OF THE DRAWINGS

FIG. 1 is a schematic representation of a bandgap reference circuit generating a single bandgap reference voltage.

FIG. 2 is a graph showing the variation of a bandgap reference voltage with respect to temperature.

FIG. 3 is a schematic representation of a bandgap reference circuit generating multiple bandgap reference voltages.

FIG. 4 is a graph showing first and second bandgap reference voltages varying with respect to temperature.

### DETAILED DESCRIPTION

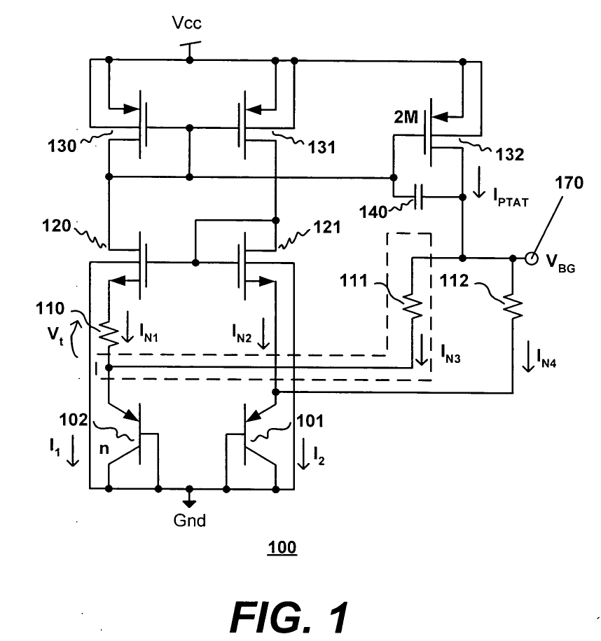

FIG. 1 shows an embodiment of a bandgap reference circuit 100 generating a single bandgap reference voltage. Bandgap reference circuit 100 includes current mirror field effect transistors (FETs) 130, 131, 120 and 121. The current mirror FETs 130, 131, 120 and 121 with current feedback mechanism are used to minimize power supply dependence. FETs 130 and 131 form a current mirror pair and FETs 120 and 121 form a regulator that, when coupled to the current mirror pair, maintains equal output voltages on the FETs 120, 121 source terminals. As shown, the FETs 130, 131 sources are coupled to the supply voltage Vcc, and the FETs 130, 131 gates are coupled to each other and to the FET 130 drain. The FETs 130, 131 substrates are coupled to Vcc. The FET 130 drain is coupled to the FET 120 drain, and FET 131 drain is coupled to the FET 121 drain. The FETs 120, 121 gates are coupled to each other and to the FET 121 drain. The FETs 120, 121 substrates are coupled to ground Gnd.

The FET 120 source is coupled to a bipolar transistor 102 emitter via resistor 110. The bipolar transistor 102 base and collector are coupled to Gnd. The FET 121 source is coupled to a bipolar transistor 101 emitter, and the bipolar transistor 101 base and collector are coupled to Gnd.

As shown in FIG. 1, the FET 130 gate and drain are coupled to the FET 132 gate and the capacitor 140. The FET 132 gate is coupled to the FET 132 drain via capacitor 140. The FET 132 source and substrate are coupled to Vcc. The FET 132 drain is coupled to the bipolar transistor 102 emitter via resistor 111, and also to the bipolar transistor 101 emitter via resistor 112. The capacitor 140 is used for frequency compensation of the bandgap circuit 100.

In the bandgap circuit 100, the bandgap reference voltage V_{BG} is measured at junction 170. The bandgap circuit 100 includes multiple current paths I_{N3} and I_{N4}, which comprise a proportional to absolute temperature current I_{PTAT} output by the current mirror FET 132. Proportional to absolute temperature (PTAT) currents vary as a linear function of absolute temperature. For example, in circuit 100, I_{PTAT}, I_{N3} and I_{N4}, are proportional to absolute temperature currents that vary as a linear function of absolute temperature. As shown, current I_{PTAT} flows into junction 170, and current paths I_{N3} and I_{N4} flow out of junction 170. Thus, I_{PTAT}=I_{N3}+I_{N4}. Current I_{N3} flows through a first current path including resistor 111, while current I_{N4} flows through a second current path including resistor 112. Current I_{N3} combines with current I_{N1}, flowing through resistor 110, to form current I₁, flowing through bipolar transistor 102. Current I_{N4} combines with current I_{N2} to form current I₂, flowing through bipolar transistor 101.

The following describes how the bandgap reference voltage V_{BG}, measured at junction 170 in circuit 100, is calculated. As shown in FIG. 1, a voltage drop Vₜ is measured across resistor 110. Voltage Vₜ is proportional to the thermal voltage V_{T} (described below). If FETs 120 and 121 and FETs 130 and 131 are the same size, then current I_{N1} (i.e., flowing through resistor 110) may be substantially the same as I_{N2}. For example, if FETs 130, 131, 120 and 121 are sized properly, the two currents I_{N1} and I_{N2} may be within 1% of each other. Current I_{N2}, dependent on absolute temperature, can be calculated by the following formula:
I_{N1}=I_{N2}=Vₜ/R₁₁₀,
where Vt is the voltage drop across the resistor 110 and R₁₁₀ is the resistance across resistor 110.

The current I_{PTAT} is a multiple of current I_{N1} since FETs 130, 131, 132 are current mirror transistors. As configured, the size of FET 132 is 2M times the size of FETs 130 or 131, where M is an arbitrary constant. The fact that FET 132 is 2M times the size of FETs 130 or 131 magnifies the current I_{PTAT} by a factor of 2M. Thus, I_{PTAT}/I_{N1}=2M, or I_{PTAT}=2M×I_{N1}. For simplicity and initial design purposes, resistors 111 and 112 are of the same resistance, and the currents I_{N3} and I_{N4} are the same, in which case, I_{N3}=I_{N4}=M×I_{N1}. However, currents I_{N3} and I_{N4} may not be equal if bipolar transistors 102 and 101 are different in size. In other words, if bipolar transistors 102 and 101 are different sizes, the base to emitter voltage V_{BE} of bipolar transistors 102 and 101 is not equal to each other, thus currents I_{N3} and I_{N4} will be different.

Based on the above, current I₁, through bipolar transistor 102, can be calculated by the following formula:
I₁=I_{N1}+I_{N3}=I_{N1}+M×I_{N1}=(1+M)I_{N1}.
Current I₂, through bipolar transistor 101, can be calculated by the following formula:
I₂=I_{N2}+I_{N4}=I_{N1}+M×I_{N1}=(1+M)I_{N1}=I₁.
The currents I₁ and I₂ may not be the same if currents I_{N3} and I_{N4} are different due to the size difference between bipolar transistors 102 and 101. The size difference between bipolar transistors 102 and 101 results in a difference between the base to emitter voltage V_{BE} of bipolar transistors 102 and 101. Consequently, the currents I₁ and I₂ are not equal to each other. The difference in currents I₁ and I₂ is compensated by adjusting the resistor 110 from an initial design value.

The base to emitter voltage V_{BE102} across the bipolar transistor 102 and the base to emitter voltage V_{BE101} across the bipolar transistor 101 can be calculated based on the following formulas:
V_{BE102}=V_{T}×ln(I₁/nlₛ), and
V_{BE101}=V_{T}×ln(I₂/Iₛ),
where V_{T} is the thermal voltage and Iₛ is the bipolar transistor saturation current, a constant. The thermal voltage V_{T} is calculated based on the following formula:
V_{T}=k×T/q,
where k is Boltzmann's constant (1.3805×10⁻²³ J/° K), T is the temperature in degrees Kelvin, and q is the electrical charge of an electron (1.6021×10⁻¹⁹ C).

Therefore, the voltage across the resistor Vₜ, 110 is:
Vₜ=V_{T}×ln(n),
where n is the ratio of the bipolar transistor 102 emitter area and the bipolar transistor 101 emitter area. Therefore, as indicated above, the voltage Vₜ across resistor 110 is proportional to the thermal voltage V_{T}.

As shown above, the PTAT current I_{PTAT} at the FET 132 is:
I_{PTAT}=2M×I_{N1}.

Since I_{N1}=Vₜ/R₁₁₀ and Vₜ=V_{T}ln(n), then I_{PTAT} can be calculated by the following:
I_{PTAT}=2M×(V_{T}/R₁₁₀)×ln(n).

The bandgap reference voltage V_{BG} can be calculated by adding the voltage drop across resistor 111 with the voltage drop V_{BE102} across bipolar transistor 102 or by adding the voltage drop across resistor 112 with the voltage drop V_{BE101} across bipolar transistor 101. The voltage drop across resistor 111 is V_{R111}=I_{N3}×R₁₁₁, where R₁₁₁ is the resistance of resistor 111 and I_{N3} is the current flowing through resistor 111. The voltage drop across resistor 112 is V_{R112}=I_{N4}×R₁₁₂, where R₁₁₂ is the resistance of resistor 112 and I_{N4} is the current flowing through resistor 112. Therefore, the bandgap reference voltage V_{BG} can be calculated by the following:
V_{BG}=V_{BE102}+I_{N3}×R₁₁₁=V_{BE101}+I_{N3}×R₁₁₂.

Assuming that the current I_{PTAT} is evenly divided between resistors 111 and 112, then I_{N3}=I_{PTAT}/2 and I_{N4}=I_{PTAT}/2. Thus, the bandgap reference voltage V_{BG} can also be represented by the following:
V_{BG}=V_{BE102}+I_{PTAP}/2×R₁₁₁=V_{BE101}+I_{PTAP}/2×R₁₁₂.

As described herein, the bandgap reference circuit 100 provides a single bandgap reference voltage V_{BG} using multiple proportional to absolute temperature current paths I_{N3} and I_{N4}.

If only a single current path is used, such as I_{N4}, it is very important to match the resistors 112 and 110 to have the required ratio needed to achieve a stable bandgap reference voltage. For example, any mismatch between the resistors 112 and 110, in a single current path bandgap circuit (not shown), may cause increased variation of bandgap reference voltage with temperature, which is undesirable.

In the case of a single current path bandgap circuit, assuming the variation in the bandgap reference voltage with temperature is ΔV. However, using the bandgap reference circuit 100 of FIG. 1, a mismatch of resistors 110 and 112, similar to the mismatch between resistors in a single current path bandgap circuit (as described above), will result in variation of bandgap reference voltage with temperature being less than ΔV. In other words, if there is a mismatch between resistors 110 and 112 in circuit 100, then the mismatch between resistors 110 and 112 will cause some variation in the bandgap reference voltage with respect to temperature. However, due to the multiple current paths, such as I_{N3} and I_{N4}, that flow into the two bipolar transistors 102 and 101, respectively, the amount of variation in bandgap reference voltage, in circuit 100, depends on the mismatch ratio of R₁₁₁/R₁₁₀ and R₁₁₂/R₁₁₀. Thus, if only one mismatch occurs, such as between resistor 110 and 112, then the amount of variation of bandgap reference voltage is less than ΔV, the variation in a single current path bandgap circuit. In the case of two current paths, as in circuit 100, the variation of the bandgap reference voltage with temperature may be almost half of ΔV. In circuit 100, using multiple current paths, slight variations between resistors 110 and 112, and/or 110 and 111 will impact the bandgap reference voltage V_{BG} less, as compared to using a single current path.

In embodiments of the bandgap circuit 100, three, four or more current paths may be used to provide a stable bandgap reference voltage.

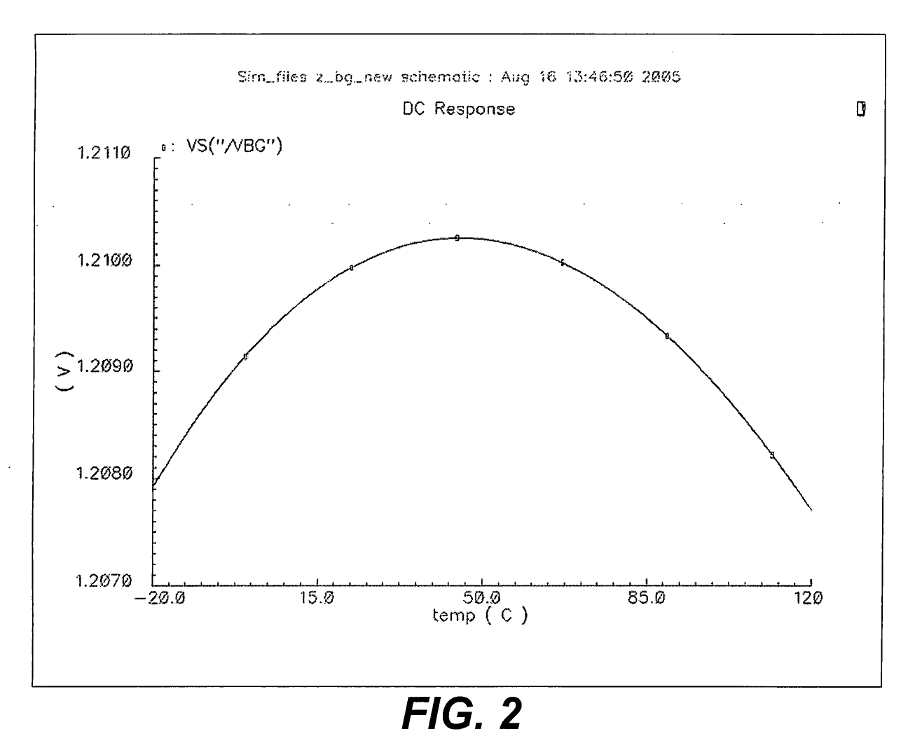

FIG. 2 is a graph 200 showing the bandgap reference voltage V_{BG} (V) with respect to temperature (° C.). The graph 200 is based on a circuit simulation of circuit 100 using a chartered semiconductor manufacturing (CSM) process. In this example, a 0.35 μm CSM process is used with the following parameters: V_{cc}=3V, n=8, M=2, R₁₁₀=20 kOhm and R₁₁₁=R₁₁₂=91 kOhm. As shown, the bandgap reference voltage V_{BG} varies from approximately 1.2080 V at −20° C. to a peak of approximately 1.2102 V at 44° C., before dropping down in voltage. Therefore, the change in voltage between the temperature range of −20° C. and 44° C. is approximately 2.2 mV.

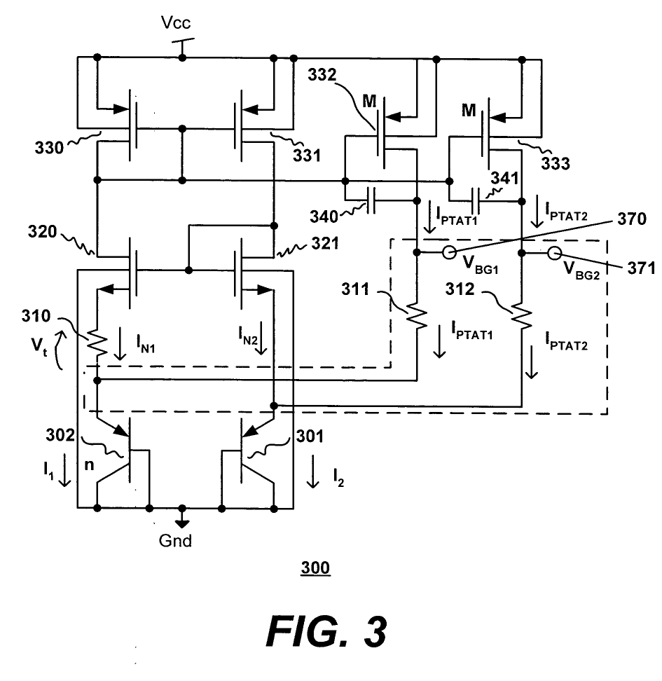

FIG. 3 shows an embodiment of a bandgap reference circuit 300 generating multiple bandgap reference voltages. Bandgap reference circuit 300 includes current mirror FETs 330, 331, 320 and 321. The current mirror transistors 330, 331, 320 and 321 with current feedback mechanism are used to minimize power supply dependence. FETs 330 and 331 form a current mirror pair and FETs 320 and 321 form a regulator that, when coupled to the current mirror pair, maintains equal output voltages on the FETs 320, 321 source terminals. As shown, the FETs 330, 331 sources are coupled to the supply voltage Vcc, and the FETs 330, 331 gates are coupled to each other. The FETs 330, 331 gates are also coupled to the FET 330 drain. The FETs 330, 331 substrates are coupled to Vcc. The FETs 330, 331 drains are coupled to the FETs 320, 321 drains, respectively. The FETs 320, 321 gates are coupled to each other and to the FET 321 drain. The FETs 320, 321 substrates are coupled to Gnd.

The FET 320 source is coupled to bipolar transistor 302 emitter via resistor 310. The bipolar transistor 302 base and collector are coupled to Gnd. The FET 321 source is coupled to bipolar transistor 301 emitter, and the bipolar transistor 301 base and collector are coupled to Gnd.

As shown in FIG. 3, the FET 330 gate and drain are coupled to the FET 332 gate and to capacitor 340. The FET 332 gate is coupled to FET 332 drain via capacitor 340. The FET 332 source and substrate are coupled to Vcc. The FET 332 drain is coupled to bipolar transistor 302 emitter via resistor 311. The capacitor 340 is used for the frequency compensation of the bandgap circuit.

The FET 330 gate and drain are also coupled to FET 333 gate and capacitor 341. The FET 333 gate is coupled to FET 333 drain via capacitor 341. The FET 333 source and substrate are coupled to Vcc. The FET 333 drain is coupled to bipolar transistor 301 emitter via resistor 312. The capacitor 341 is used for frequency compensation of the bandgap circuit.

In the bandgap circuit 300, a first bandgap reference voltage V_{BG1} is measured at junction 370, while a second bandgap reference voltage V_{BG2} is measured at junction 371. The bandgap circuit 300 includes a first proportional to absolute temperature (PTAT) current path I_{PTAT1} flowing into and out of junction 370. The bandgap circuit 300 also includes a second PTAT current path I_{PTAT2} flowing into and out of junction 371. Current I_{PTAT1} flows through first current path including resistor 311, while current I_{PTAT2} flows through second current path including resistor 312. Current I_{PTAT1} combines with current I_{N1}, flowing through resistor 311, to form current I₁, flowing through bipolar transistor 302. Current I_{PTAT2} combines with current I_{N2}, flowing out of the drain of FET 321, to form current I₂, flowing through bipolar transistor 301. Current I_{N1} is based on the FETs 320, 321, 330 and 331 together with bipolar transistors 302 and 301 and the resistor 310. The FETs 332 and 333 will mirror the current I_{N1} with the multiplication factor of M.

The voltage across the resistor Vₜ, 310 is:
Vₜ=V_{T}×ln(n),
where n is the ratio of the bipolar transistor 302 emitter area and the bipolar transistor 301 emitter area.

For simplicity, the sizes of FETs 332 and 333 are the same. The size of FET 332 is M times the size of FETs 330 or 331, magnifying the current I_{PTAT1} by a factor of M. Therefore, the current I_{PTAT1}, at FET 332, is:
I_{PTAT1}=M×I_{N1}=M×(V_{T}/R₃₁₀)×ln(n),
where R₃₁₀ is the resistance of resistor 310.

Due to current mirror of the FETs, 330, 331, 332, 333, the current I_{PTAT2} at FET 333 is:
I_{PTAT2}=M×I_{N1}=M×(V_{T}/R₃₁₀)×ln(n)=I_{PTAT1}
Therefore, the current I_{PTAT2} is the same as the current I_{PTAT1}.

The first bandgap reference voltage V_{BG1} can be calculated by adding the voltage drop across resistor 311 with the voltage drop across bipolar transistor 302. The voltage drop across bipolar transistor 302 is the base-emitter voltage V_{BE302} of bipolar transistor 302. The second bandgap reference voltage V_{BG2} can be calculated by adding the voltage drop across resistor 312 with the voltage drop across bipolar transistor 301. The voltage drop across bipolar transistor 301 is the base-emitter voltage V_{BE301} of bipolar transistor 301. The voltage drop across resistor 311 is V_{R311}=I_{PTAT1}×R₃₁₁, where R₃₁₁ is the resistance of resistor 311. The voltage drop across resistor 312 is V_{R312}=I_{PTAT2}×R₃₁₂, where R₃₁₂ is the resistance of resistor 312. Thus, the bandgap reference voltage V_{BG1} and V_{BG2} can be represented as:
V_{BG1}=V_{BE302}+I_{PTAP1}×R₃₁₁=V_{BE302}+M×(V_{T}/R₃₁₀)×ln(n)×R₃₁₁, and
V_{BG2}=V_{BE301}+I_{PTAP2}×R₃₁₂=V_{BE301}+M×(V_{T}/R₃₁₀)×ln(n)×R₃₁₂.

In the above equations for calculating V_{BG1} and V_{BG2}, n is a ratio of bipolar transistor 302 emitter area and bipolar transistor 301 emitter area, V_{T} is the thermal voltage, M is a ratio of FET current mirror 332 and FET current mirror 333, and R₃₁₀ is the resistance of resistor 310.

The bandgap reference circuit 300 provides multiple bandgap reference voltages V_{BG1} and V_{BG2} using multiple proportional to absolute temperature current paths I_{PTAT1} and I_{PTAT2}. The multiple bandgap reference voltages V_{BG1} and V_{BG2} can be used to provide independent internal reference voltages for various circuit applications.

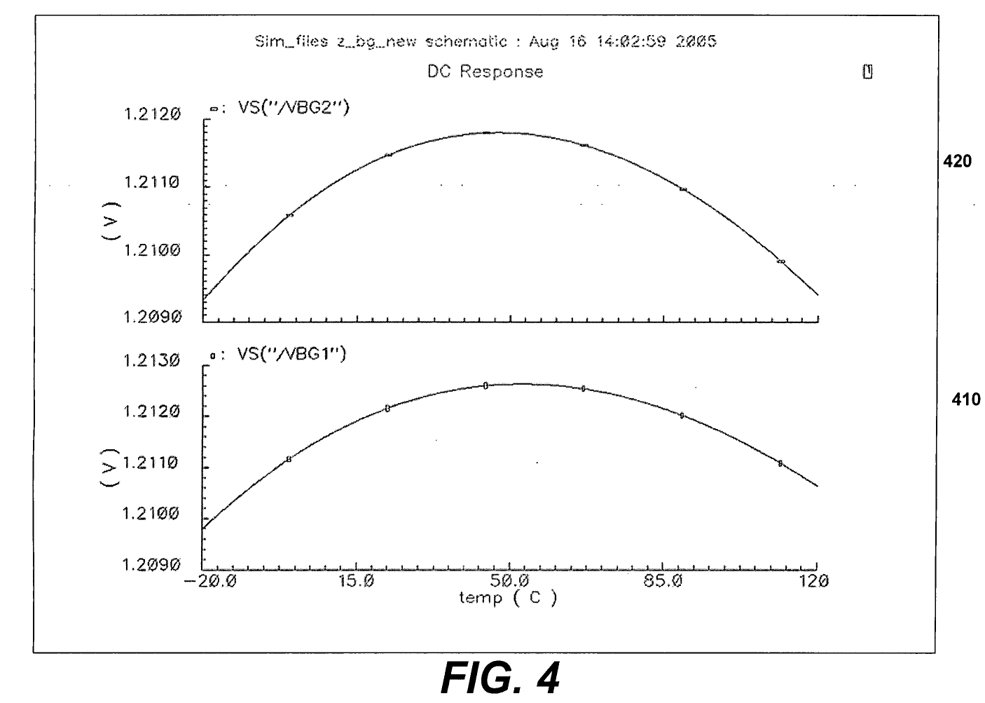

FIG. 4 shows a graph 410 showing a first bandgap reference voltage V_{BG1} (V) with respect to temperature (° C.) and graph 420 showing a second bandgap reference voltage V_{BG2} (V) with respect to temperature (° C.). The graphs 410 and 420 are based on a circuit simulation of circuit 300, shown in FIG. 3. In this example, a 0.35 μm CSM process is used with the following parameters: V_{cc}=3V, n=8, M=2, R₃₁₀=20 kOhm, R₃₁₁=93 kOhm and R₃₁₂=91 kOhm. The values of R₃₁₁ and R₃₁₂ are different to compensate for the difference between the emitter areas of bipolar transistors 302 and 301. The difference is emitter areas of bipolar transistors 302 and 301 affects the V_{BE} voltages of the bipolar transistors 302 and 301. As shown in graph 410, the first bandgap reference voltage V_{BG1} varies from approximately 1.2098 V at −20° C. to a peak of approximately 1.2126 V at 52° C. As shown in graph 420, the second bandgap reference voltage V_{BG2} varies from approximately 1.2093 V at −20° C. to a peak of approximately 1.2117 V at 50° C. Therefore, the change in voltage between the temperature range of −20° C. to 52° C. is approximately 2.8 mV for V_{BG1}, and 2.4 mV for V_{BG2}.

1. A bandgap reference circuit for generating an output bandgap reference voltage, comprising:
A first FET current mirror comprising first sources, first gates and first drains, the first sources being coupled to a supply voltage, the FET current mirror generating a proportional to absolute temperature current at an output node that outputs the bandgap reference voltage;
an FET current regulator comprising second sources, second gates and second drains, the second drains and second gates being coupled to the first gates and first drains;
a second FET current mirror comprising at least a third source, a third gate and a third drain, the third source being coupled to the supply voltage, the third gate and third drain being coupled to the output node;
a first current path including a first resistor coupled between the output node and a first bipolar transistor comprising a first collector; and
a second current path including a second resistor coupled between the output node and a second bipolar transistor comprising a second collector; wherein the first current path is parallel to the second current path and the first and second collectors are coupled to ground.

2. The bandgap reference circuit of claim 1, wherein the proportional to absolute temperature current flows into the first current path and the second current path at the output node.

3. The bandgap reference circuit of claim 1, wherein the proportional to absolute temperature current flows equally through the first current path and the second current path at the output node.

4. (canceled)

5. The bandgap reference circuit of claim 1, further comprising:
a third resistor coupled to the first bipolar transistor, wherein the current flowing through the third resistor is proportional to the proportional to absolute temperature current.

6. The bandgap reference circuit of claim 1, wherein the bandgap reference voltage output by the output node is represented by one of:
a sum of a first voltage across the first resistor and a first base-emitter voltage of the first bipolar transistor; and
a sum of a second voltage across the second resistor and a second base-emitter voltage of the second bipolar transistor.

7. The bandgap reference circuit of claim 1, wherein the bandgap reference voltage output by the output node is determined by:
V_{BE1}+I_{N3}×R₁=V_{BE2}+I_{N4}×R₂,
wherein V_{BE1} is a base to emitter voltage across the first bipolar transistor, I_{N3} is a value of the proportional to absolute temperature current flowing across the first resistor, R₁ is a resistance of the first resistor, V_{BE2} is a base to emitter voltage across the second bipolar transistor, I_{N4} is a value of the proportional to absolute temperature current flowing across the second resistor and R₂ is a resistance of the second transistor.

8. The bandgap reference circuit of claim 7, wherein a current flowing through the first current path is substantially the same as a current flowing through the second current path.

9. The bandgap reference circuit of claim 1, further comprising:
a capacitor, wherein the first drains and third gate are coupled to the output node, and the capacitor is coupled to the first gates, the first drains and the third drain.

10. The bandgap reference circuit of claim 1, wherein the bandgap reference voltage is proportional to the proportional to absolute temperature current.

11. A bandgap reference circuit for generating a plurality of output reference voltages, comprising:
A first FET current mirror comprising first sources, first gates and first drains, the first sources being coupled to a supply voltage, the FET current mirror generating a first proportional to absolute temperature current to a first output node that outputs a first bandgap reference voltage;
a first current path including a first resistor coupled between the first output node and a first bipolar transistor comprising a first collector;
an FET current regulator comprising second sources, second gates and second drains, the second drains and second gates being coupled to the first gates and first drains, the FET current regulator generating a second proportional to absolute temperature current to a second output node that outputs a second bandgap reference voltage;
a second FET current mirror comprising at least a third source, a third gate and a third drain, the third source being coupled to the supply voltage, the third gate and third drain being coupled to at least one of the first output node and the second output node; and
a second current path including a second resistor coupled between a second output node and a second bipolar transistor comprising a second collector;
wherein the first and second collectors are coupled to ground.

12. The bandgap reference circuit of claim 11, wherein the first proportional to absolute temperature current flows through the first current path and the second proportional to absolute temperature current flows through the second current path, and the first proportional to absolute temperature current is equal to the second proportional to absolute temperature current.

13. (canceled)

14. The bandgap reference circuit of claim 11, further comprising:
a capacitor is coupled to at least one of the first and second gates and the third drain.

15. The bandgap reference circuit of claim 11, further comprising:
a third resistor coupled to the first bipolar transistor, wherein the current flowing through the third resistor is proportional to the first proportional to absolute temperature current.

16. The bandgap reference circuit of claim 11, wherein the first bandgap reference voltage output by the first output node is represented by a sum of a voltage across the first resistor and a base-emitter voltage of the first bipolar transistor.

17. The bandgap reference circuit of claim 11, wherein the second bandgap reference voltage output by the second output node is represented by a sum of a voltage across the second resistor and a base-emitter voltage of the second bipolar transistor.

18. The bandgap reference circuit of claim 11, wherein the first bandgap reference voltage output by the first output node is determined by:
V_{BE1}+I_{PTAP1}×R₁=V_{BE1}+M×(V_{T}/R₃)×ln(n)×R₁,
wherein V_{BE1} is a base to emitter voltage across the first bipolar transistor, I_{PTAP1} is a value of the first proportional to absolute temperature current, R₁ is a resistance of the first resistor, n is a ratio of an emitter area of the second bipolar transistor and an emitter area of the first bipolar transistor, V_{T} is a thermal voltage, M is a ratio of the FET current mirror and the FET current regulator, and R₃ is a resistance of a third resistor.

19. The bandgap reference circuit of claim 11, wherein the second bandgap reference voltage output by the second output node is determined by:
V_{BE2}+I_{PTAP2}×R₂=V_{BE2}+M×(V_{T}/R₃)×ln(n)×R₂,
wherein V_{BE2} is a base to emitter voltage across the second bipolar transistor, I_{PTAP2} is a value of the second proportional to absolute temperature current, R₂ is a resistance of the second transistor, n is a ratio of an emitter area of the second bipolar transistor and an emitter area of the first bipolar transistor, V_{T} is a thermal voltage, M is a ratio of the FET current mirror and the FET current regulator, and R₃ is a resistance of a third resistor.

20. (canceled)
